(19) United States
(12) Patent Application Publication
(10) Pub. No.: US 2023/0342211 A1
(43) Pub. Date: Oct. 26, 2023

(54) METHOD AND DEVICE FOR CONTROLLING HARDWARE ACCELERATOR BY USING SW FRAMEWORK STRUCTURE HOMOGENEOUS MULTI-CORE ACCELERATOR FOR SUPPORTING ACCELERATION OF TIME-CRITICAL TASK

(71) Applicant: MOBILINT INC., Seoul (KR)

(72) Inventor: Jisung KIM, Seoul (KR)

(73) Assignee: MOBILINT INC., Seoul (KR)

(21) Appl. No.: 18/343,626

(22) Filed: Jun. 28, 2023

Related U.S. Application Data
(63) Continuation of application No. PCT/KR2022/008120, filed on May 27, 2022.

(30) Foreign Application Priority Data
Dec. 24, 2021 (KR) 10-2021-0186930

(51) Int. Cl. G06F 9/50; G06F 9/48

(52) U.S. Cl. CPC G06F 9/5044; G06F 9/4887

(57) ABSTRACT

Disclosed is a hardware accelerator controlling method performed by a hardware accelerator controlling device including a hardware accelerator including at least one core and programing a time-critical task, and a software framework connected to the hardware accelerator including instantiating, by the software framework, a task force, which is a task management unit provided by the software framework, in an application, configuring metadata by using the instantiated task force in the application, and registering, by the application, the task force thus configured in the software framework.

### CROSS-REFERENCE TO RELATED APPLICATIONS

The present application is a continuation of International Patent Application No. PCT/KR2022/008120, filed on May 27, 2022, which is based upon and claims the benefit of priority to Korean Patent Application No. 10-2021-0186930 filed on Dec. 24, 2021. The disclosures of the above-listed applications are hereby incorporated by reference herein in their entirety.

### BACKGROUND

Embodiments of the inventive concept described herein relate to a method and device for controlling a hardware accelerator by using a SW framework structure of a homogeneous multi-core accelerator for supporting acceleration of a time-critical task.

As a technology for accelerating hardware in a computing system, a hardware accelerator is used to process a large amount of complex operations (hereafter referred to as a “task”) in a fast time instead of a central processing unit (CPU). For example, instead of the CPU, several hardware accelerators are being used, such as a graphic processing unit (GPU) that provides hardware acceleration specialized for graphic operations, and a neural processing unit (NPU) that provides hardware acceleration specialized for deep learning model operations.

Software support that implements hardware is required for all overall management including the start and end of a task using hardware accelerators in a computing system. All software for managing overall operations of the hardware accelerator is referred to as a “software framework”. A user may perform the desired operation through the software framework that abstracts the hardware accelerator. In particular, in terms of the start and end of a task, an operation desired by the user may be performed by detecting and monitoring the state of an accelerator by using an interrupt method or a polling method.

The polling method and the interrupt method are used as the task state monitoring method. When the polling method is used, there is a need to continuously monitor the state of a core until the task is completed. Accordingly, unnecessary consumption of CPU cycles may occur, which may reduce efficiency in a system unit. Besides, nowadays, there is a need for a hardware accelerator having dozens to hundreds of cores, not a single core. In this case, all individual cores need to be monitored, and thus when each core is monitored individually without meticulous measures, system performance may deteriorate due to an increase in the number of threads respectively corresponding to basic work units of an operating system.

In particular, system efficiency is a very important factor in a core environment that requires low power and high performance, such as an automotive NPU.

### SUMMARY

There is a need for a method of reducing unnecessary CPU cycle consumption that may occur, by using a polling method in a software framework supporting hardware accelerator. There is required for a method of fully manipulating a hardware accelerator by using minimum system resources represented by threads. At the same time, because a software framework is provided to a user as an abstract form of a hardware accelerator, a task of a hardware accelerator needs to be implemented in a format that is easy for the user to use intuitively.

An accelerator for time-critical tasks capable of determining when a task to be processed is finished among hardware accelerators may improve the performance of the entire system by utilizing the expected end time when using the polling method. Furthermore, an intuitively convenient software framework may be provided to the user by abstracting a unique operation of a general hardware accelerator having the above-described characteristics.

According to an embodiment, a hardware accelerator controlling method performed by a hardware accelerator controlling device including a hardware accelerator including at least one core and programing a time-critical task, and a software framework connected to the hardware accelerator and including a core monitor includes instantiating, by the software framework, a task force, which is a task management unit provided by the software framework, through an application, configuring metadata by using the instantiated task force, and registering, by the application, the task force thus configured in the software framework.

In an embodiment, the software framework may be configured to program the hardware accelerator based on an accelerator core setting included in the metadata of a task force requested to be registered.

In an embodiment, the method may further include making, by the application, a request for task processing to the software framework and the hardware accelerator through the instantiated task force registered in the software framework, managing a received task by adding the received task to a task queue, and providing a notification of a signal indicating that the new task is added to the core monitor by the task force when a new task is added to the task queue.

In an embodiment, the method may further include monitoring, by the core monitor, the at least one core included in the hardware accelerator, determining whether there is an available core among the at least one core when there is a task to be processed during the monitoring, and removing a task from the task queue of the task force and allocating a task to the available core of the hardware accelerator when the available core is found.

In an embodiment, a time required to process a task in a programmable hardware accelerator that processes a time-critical task may be the sum of hardware latencies of programmed instructions inside the task force. The method may further include using the latency as ETA, which is a sleep time before polling when a task is performed.

In an embodiment, a time-critical task may have the same level of latency, and thus may include an operation of setting an accelerator core, performing accelerated processing on an arbitrary input, recording the required time in a polling method, and using the time as an estimated time arrival (ETA), which is a sleep time before polling when a task is performed.

In an embodiment, the method may further include monitoring, by the core monitor, a frontmost part of the core monitoring queue, determining a priority of usage information of a core having the allocated task based on estimated time arrival (ETA) and adding the usage information to the core monitoring queue, the priority being high as the ETA is short, causing a polling task to be pending by using a sleep as much as ETA of a core at the frontmost part of the core monitoring queue when the task is completely allocated. The core at the frontmost part of the monitoring queue may be a core having the smallest ETA. The at least one core may be controlled through a single thread.

According to an embodiment, a hardware accelerator controlling device includes a hardware accelerator including at least one core and programing a time-critical task and a software framework connected to the hardware accelerator. The software framework instantiates a task force, which is a task management unit provided by the software framework, through an application, configures metadata by using the instantiated task force, and registers the task force thus configured in the software framework by the application.

In an embodiment, the software framework may be configured to program the hardware accelerator based on an accelerator core setting included in the metadata of a task force requested to be registered.

In an embodiment, the application may be further configured to make a request for task processing to the software framework and the hardware accelerator through the instantiated task force registered in the software framework, to manage a received task by adding the received task to a task queue, and to provide a notification of a signal indicating that the new task is added to the core monitor by the task force when a new task is added to the task queue.

In an embodiment, the core monitor may be further configured to monitor the at least one core included in the hardware accelerator, to determine whether there is an available core among the at least one core when there is a task to be processed during the monitoring, and to remove a task from the task queue of the task force and to allocate a task to the available core of the hardware accelerator when the available core is found.

In an embodiment, the core monitor may be further configured to monitor a frontmost part of the core monitoring queue, to determine a priority of usage information of a core having the allocated task based on ETA and add the usage information to the core monitoring queue, and to cause a polling task to be pending by using a sleep as much as ETA of a core at the frontmost part of the core monitoring queue when the task is completely allocated. The core at the frontmost part of the monitoring queue may be a core having the smallest ETA. The at least one core may be controlled through a single thread.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 illustrates a brute force structure;

FIG. 2 shows a system structure, according to various embodiments of the inventive concept;

FIG. 3A shows a block diagram for programming a hardware accelerator, according to various embodiments of the inventive concept;

FIG. 3B shows a block diagram for setting a hardware accelerator core, according to various embodiments of the inventive concept;

FIG. 4 is a block diagram for delivering a task force processing request and scheduling tasks centralized in units of task force, according to various embodiments of the inventive concept;

FIG. 5 is a diagram schematically showing a configuration of the hardware accelerator controlling device shown in FIG. 2, according to an embodiment of the inventive concept; and

FIG. 6 is a diagram briefly illustrating a basic concept of an ANN.

### DETAILED DESCRIPTION

Hereinafter, various embodiments of the inventive concept may be described with reference to accompanying drawings. However, it should be understood that this is not intended to limit the inventive concept to specific implementation forms and includes various modifications, equivalents, and/or alternatives of embodiments of the inventive concept.

In this specification, the singular form of the noun corresponding to an item may include one or more of items, unless interpreted otherwise in context. In this specification, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

Each component (e.g., a module or a program) of components described in this specification may include a single entity or a plurality of entities. According to various embodiments, one or more components of the corresponding components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

The term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC). Terms “software framework” and “core manager” used in this specification may be implemented in software.

Various embodiments of the inventive concept may be implemented with software (e.g., a program or an application) including one or more instructions stored in a storage medium (e.g., a memory) readable by a machine. For example, the processor of a machine may call at least one instruction of the stored one or more instructions from a storage medium and then may execute the at least one instruction. This may enable the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

A method according to various embodiments disclosed in the specification may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store, directly between two user devices (e.g., smartphones), or online. In the case of on-line distribution, at least part of the computer program product may be at least temporarily stored in the machine-readable storage medium such as the memory of a manufacturer's server, an application store's server, or a relay server or may be generated temporarily.

According to various embodiments disclosed in the specification, there may be a plurality of cores (e.g., NPUs) in a hardware accelerator programmable through software, and states of the cores may be detected and monitored in a polling method. A task addressed in various embodiments disclosed in the specification may have predictable latency. For example, as an example of a hardware accelerator, a deep learning model is a time-critical task in that the deep learning model has predictable latency. When processing is performed on cores by using the same accelerator architecture with the same deep learning model, the deep learning model may have the same latency.

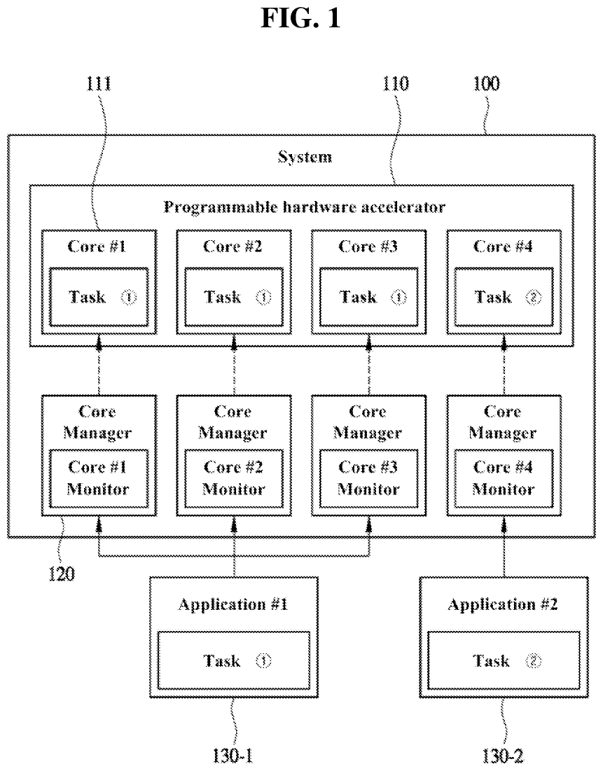

FIG. 1 illustrates a brute force structure.

The brute force structure includes a programmable hardware accelerator 110 and core managers 120 respectively corresponding to cores 111 in the hardware accelerator 110. Each of the core managers 120 includes a core monitor. The core monitor is managed by applications 130-1 and 130-2. For example, the application #1 130-1 may use core #1, core #2, and core #3 to perform “task \textcircled{1}”. The application #2 130-2 may use core #4 to perform “task \textcircled{2}”.

The brute force structure may be performed by placing a monitoring thread for each core 111 in each accelerator. In terms of performance, this brute force structure has the number of threads that increases proportionally as the number of cores increases, thereby wasting unnecessary computing resources. The brute force structure may not effectively respond to a task processing scenario (e.g., in an NPU having four cores, a scenario in which one SSD-MobileNet v1 is accelerated by using three cores, while one ResNet50 is accelerated by using one core) using a plurality of cores in terms of user convenience.

Moreover, when cores that process the same task are not grouped semantically well, a user needs \textcircled{1} to program a task to be processed, \textcircled{2} to schedule the task, and \textcircled{3} to directly deliver a task processing request to each appropriate core. Accordingly, the user feels uncomfortable, and the possibility of error increases.

To solve these issues, the introduction of a software architecture that manages an accelerator operation in units of task force, promotes semantic user convenience, and prevents wasting computing resources is required.

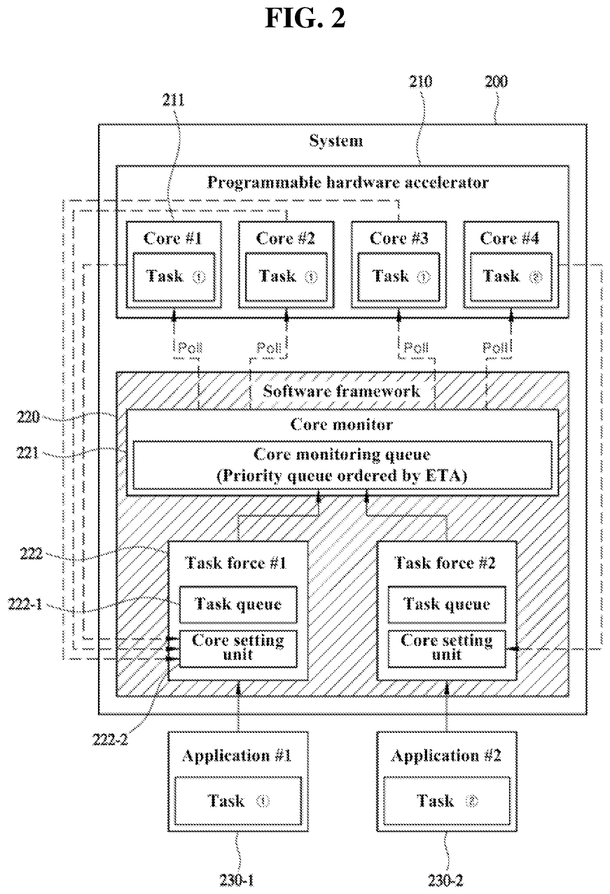

FIG. 2 shows a system structure, according to various embodiments of the inventive concept.

A system 200 according to an embodiment of the inventive concept may include a programmable hardware accelerator 210 and a software framework 220.

The programmable hardware accelerator 210 according to an embodiment of the inventive concept may include one or more cores 211.

The software framework 220 according to an embodiment of the inventive concept may include a core monitor 221 and one or more task forces 222. The core monitor 221 may be managed through the software framework 220 from the applications 230-1 and 230-2. Each of the task forces 222 may include a task queue 222-1 including a list of minimum tasks to be processed and a core setting unit 222-2 including metadata for setting a core. For example, the application #1 230-1 may use core #1, core #2, and core #3 to perform “task \textcircled{1}”. The application #2 230-2 may use core #4 to perform “task \textcircled{2}”. In the meantime, the core monitor 221 may include a core monitoring queue (a priority queue ordered by ETA).

Furthermore, the software framework 220 may poll each core through the core monitor 221.

When there are four cores inside the hardware accelerator 210, there are four threads. Each core may be polled to be dedicated to one thread. However, when the number of cores increases, the number of threads increases as much as the number of cores. Accordingly, additional threads increase the burden, and performance may deteriorate due to polling that occurs in the corresponding thread.

According to an embodiment of the inventive concept, polling operations of the four cores may be controlled by one thread. In other words, a core monitoring queue in the core monitor 221 includes information of each of the cores 211 (e.g., in case of four cores, there are four pieces of data inside a queue). A core (i.e., a core closest to completing an operation) having the fastest ETA, which is a time remaining until an operation of the core is completed, is positioned at the frontmost part of the queue by using ETA as a priority. The core monitor 221 monitors the frontmost part of a core monitoring queue. In this case, because it is inefficient to perform a polling operation when ETA has not yet arrived. Next, the core monitor 221 may interrupt the polling operation for a while as much as the ETA time (i.e. switching to a sleep state). When ETA arrives, the core monitor 221 may start the polling operation of the corresponding core, and the corresponding core may be moved to the end location of the monitoring queue. That is, as the ETA is short, the priority is high.

According to the system structure according to various embodiments, \textcircled{1} cores that perform the same task may be grouped through a task force, and task management methodology such as scheduling may be centralized and managed in units of task force. In addition, \textcircled{2} computing resource waste may be minimized by reducing the number of threads to one, adjusting polling timing by using the fact that there is predictable latency, and referring to a priority queue maintained based on the ETA of core operation results based on the predictable latency.

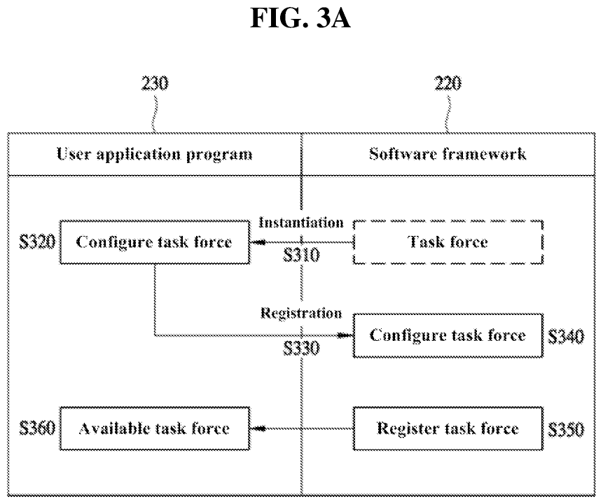

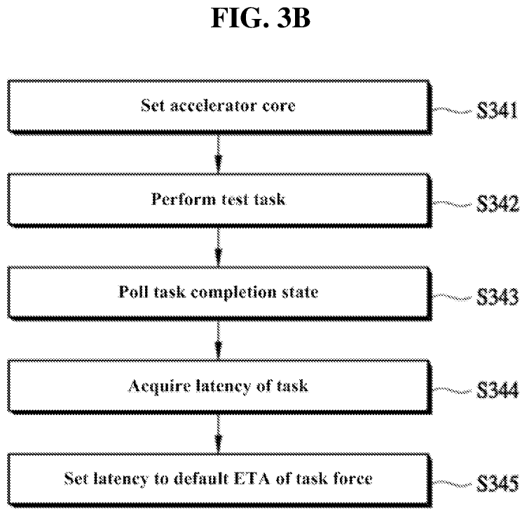

FIG. 3A shows a block diagram for programming a hardware accelerator, according to various embodiments of the inventive concept.

Configuration of Task Force

In step S310, a user application program 230 (e.g., an application) may instantiate a task force, which is an abstracted task management unit provided by a software framework.

In step S320, the user application program 230 (e.g., the applications 230-1 and 230-2) may configure necessary metadata by using the instantiated task force.

Information required for the task force may be the task queue 222-1 including a list of tasks to be processed at a minimum, and the core setting unit 222-2 including metadata for core settings.

Registration of Task Force

In step S330, the application 230 may register the configured task force in the software framework 220. The software framework may program a hardware accelerator based on accelerator core settings included in the metadata of the task force requested to be registered, and may set data inside the software framework according to other metadata.

Available Task Force

The application 230 may consistently process tasks having the same type by using the registered task force instance.

According to hardware accelerator programming in accordance with various embodiments, a task may be consistently processed by using pre-registered task force instance.

FIG. 3B shows a block diagram for setting a hardware accelerator core, according to various embodiments of the inventive concept.

In step S341, the software framework 220 starts an operation of setting an accelerator core.

Execution of Test Task

In step S342, a test task is performed. The test task is a dummy task, not a task of deriving an operation result. The latency of a specific task may be obtained through the test task.

In step S343, a task completion state is polled.

Acquisition of Task Latency

In step S344, the core monitor 221 acquires a time from a point in time when a task is performed to a point in time when the task is completed, as the latency of the task. In an embodiment, a time-critical task may have the same level of latency, and thus may include an operation of setting an accelerator core, performing accelerated processing on an arbitrary input, recording the required time in a polling method, and using the time as an estimated time arrival (ETA), which is a sleep time before polling when a task is performed.

In step S345, the corresponding latency is set to the default ETA of the corresponding task force. In an embodiment, a time required to process a task in a programmable hardware accelerator that processes a time-critical task may be the sum of hardware latencies of programmed instructions inside the task force. The latency may be used as ETA, which is a sleep time before polling when a task is performed.

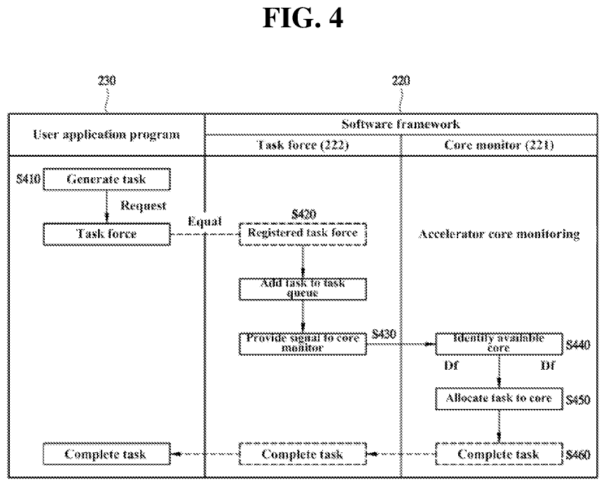

FIG. 4 is a block diagram for delivering a task force processing request and scheduling tasks centralized in units of task force, according to various embodiments of the inventive concept.

Generation of Task

In step S410, the application 230 (e.g., the applications 230-1 and 230-2) may generate a task to be processed by the software framework 220.

Request to Task Force

In step S420, the application 230 may make a request for task processing to the software framework 220 and the hardware accelerator 210 through a task force instance successfully registered in the software framework 220.

Addition of Task to Task Queue and Notification of Signal to Core Monitor

In step S430, all received tasks may be managed by adding the received tasks to the task queue 222-1. When a new task is added to a task queue, the task force 222 may notify the core monitor 221 of a signal indicating that a new task is added, may temporarily release a sleep state of the core monitor 221, and may make monitoring resume again.

Check Available Core and Allocation of Task

In step S440, the core monitor 221 may continuously monitor all the cores 211 of the accelerator 210.

In step S450, the core monitor 221 determines whether there is an available core among the at least one core when there is a task to be processed, removes a task from the task queue of the task force, and allocates a task to the available core of the hardware accelerator when the available core is found. The priority of usage information of a core having the allocated task is determined based on ETA, and the usage information is added to the core monitoring queue. When the task is completely allocated, a polling task may be caused to be pending by using a sleep as much as ETA of a core at the frontmost part (having the smallest ETA) of the core monitoring queue.

For example, polling operations of the four cores may be controlled by one thread. In other words, a core monitoring queue in the core monitor 221 includes information of each of the cores 211. For example, in case of four cores, there are four pieces of data inside a queue. A core (i.e., a core closest to completing an operation) having the fastest ETA, which is a time remaining until an operation of the core is completed, may be positioned at the frontmost part of the queue by using the ETA as a priority. In this case, because it is inefficient for the core monitor 221 to monitor the frontmost part of the core monitoring queue and to perform a polling operation when ETA has not yet arrived, the core monitor 221 may interrupt the polling operation for a while as much as the ETA (i.e. switching to a sleep state). Next, When ETA arrives, the core monitor 221 may start the polling operation of the corresponding core, and the corresponding core may be moved to the end location of the monitoring queue.

Completion of Task

In step S460, when the core monitor 221 wakes up from a sleep state due to ETA expiry, the core monitor 221 may wait for the task to be completed by monitoring a core in a polling method. When the state of core is changed to a completion state, a task completion signal may be delivered to the application 230.

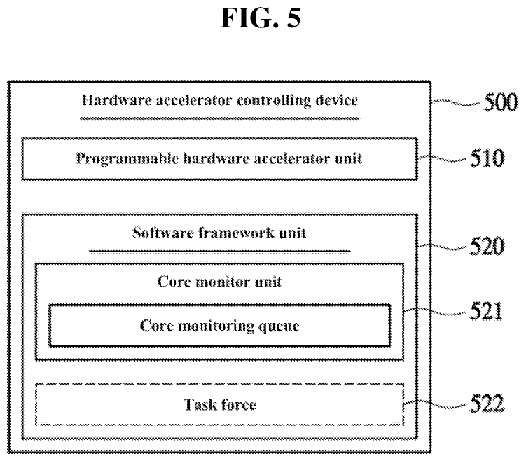

FIG. 5 is a diagram schematically showing a configuration of the hardware accelerator controlling device shown in FIG. 2, according to an embodiment of the inventive concept.

A hardware accelerator controlling device 500 according to an embodiment of the inventive concept may include a programmable hardware accelerator unit 510 and a software framework unit 520.

The software framework unit 520 may include a core monitor unit 521 and a task force 522. The core monitor unit 521 may include a core monitoring queue.

The task force 522 may register a task force, which is configured by an application, in the software framework unit 520.

A deep learning algorithm applicable to the inventive concept will be described below.

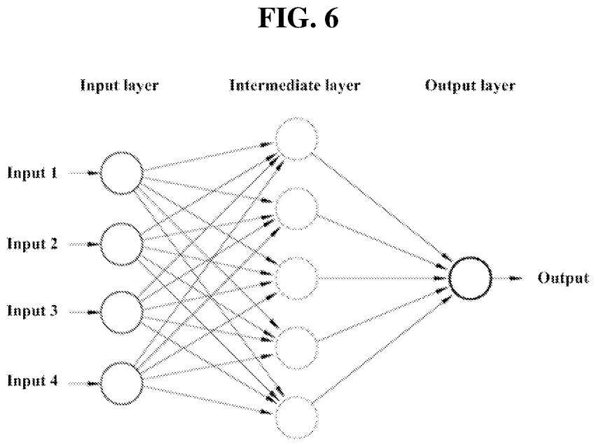

The deep learning algorithm is one of machine learning algorithms and refers to a modeling technique developed from an artificial neural network (ANN) created by mimicking a human neural network. The ANN may be configured in a multi-layered structure as shown in FIG. 6.

FIG. 6 is a diagram briefly illustrating a basic concept of an ANN.

As shown in FIG. 6, the ANN may have a hierarchical structure including an input layer, an output layer, and at least one or more intermediate layers (or hidden layers) between the input layer and the output layer. On the basis of a multi-layered structure, the deep learning algorithm may derive highly reliable results through learning to optimize a weight of an interlayer activation function.

The deep learning algorithm applicable to the inventive concept may include a deep neural network (DNN), a convolutional neural network (CNN), a recurrent neural network (RNN), and the like.

The DNN basically improves learning results by increasing the number of intermediate layers (or hidden layers) in a conventional ANN model. For example, the DNN performs a learning process by using two or more intermediate layers.

Accordingly, a computer may derive an optimal output value by repeating a process of generating a classification label by itself, distorting space, and classifying data.

Unlike a technique of performing a learning process by extracting knowledge from existing data, the CNN has a structure in which features of data are extracted and patterns of the features are identified. The CNN may be performed through a convolution process and a pooling process. In other words, the CNN may include an algorithm complexly composed of a convolution layer and a pooling layer. Here, a process of extracting features of data (called a “convolution process”) is performed in the convolution layer. The convolution process may be a process of examining adjacent components of each component in the data, identifying features, and deriving the identified features into one layer, thereby effectively reducing the number of parameters as one compression process. A process of reducing the size of a layer from performing the convolution process (called a “pooling process”) is performed in a pooling layer. The pooling process may reduce the size of data, may cancel noise, and may provide consistent features in a fine portion. For example, the CNN may be used in various fields such as information extraction, sentence classification, and face recognition.

The RNN is a type of artificial neural network specialized in repetitive and sequential data learning, and has a recurrent structure therein. The RNN has a feature that enables a link between present learning and past learning and depends on time, by applying a weight to past learning content by using the circular structure to reflect the applied result to present learning. The RNN may be an algorithm that solves the limitations in learning conventional continuous, repetitive, and sequential data, and may be used to identify speech waveforms or to identify components before and after a text.

However, these are only examples of specific deep learning techniques applicable to the inventive concept, and other deep learning techniques may be applied to the inventive concept according to an embodiment.

Additionally, a computer program according to an embodiment of the inventive concept may be stored in a computer-readable recording medium to execute various hardware accelerator controlling methods described above while being combined with a computer.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

Steps or operations of the method or algorithm described with regard to an embodiment of the inventive concept may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the inventive concept pertains.

Although an embodiment of the inventive concept are described with reference to the accompanying drawings, it will be understood by those skilled in the art to which the inventive concept pertains that the inventive concept may be carried out in other detailed forms without changing the scope and spirit or the essential features of the inventive concept.

Therefore, embodiments disclosed in the specification are intended not to limit but to explain the technical idea disclosed in the specification, and the scope of the technical idea disclosed in the specification is not limited by this embodiment. The scope of protection disclosed in the specification should be construed by the attached claims, and all equivalents thereof should be construed as being included within the scope of the specification.

A semantic user convenience such as grouping cores that perform the same task, scheduling the cores, and centralizing and managing a task management methodology may be promoted by providing a minimum abstraction (task force) suitable for properties of a task performed by the time-critical accelerator.

Moreover, system resources may be prevented from being wasted by keeping the number of threads monitoring multi-core to a minimum. The overall system performance may be improved by excluding polling from the hardware accelerator as much as the required unnecessary time by performing time-critical tasks.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A hardware accelerator controlling method performed by a hardware accelerator controlling device including a hardware accelerator including at least one core and configured to program a time-critical task, and a software framework connected to the hardware accelerator and including a core monitor, the method comprising:
instantiating, by the software framework, a task force, which is a task management unit provided by the software framework, through an application;
configuring metadata by using the instantiated task force; and
registering, by the application, the task force thus configured in the software framework.

2. The method of claim 1, wherein the software framework is configured to:
program the hardware accelerator based on an accelerator core setting included in the metadata of a task force requested to be registered.

3. The method of claim 2, further comprising:
making, by the application, a request for task processing to the software framework and the hardware accelerator through the instantiated task force registered in the software framework;
managing a received task by adding the received task to a task queue; and
when a new task is added to the task queue, providing a notification of a signal indicating that the new task is added to the core monitor by the task force.

4. The method of claim 3, further comprising:
monitoring, by the core monitor, the at least one core included in the hardware accelerator;
when there is a task to be processed during the monitoring, determining whether there is an available core among the at least one core; and
when the available core is found, removing a task from the task queue of the task force and allocating a task to the available core of the hardware accelerator.

5. The method of claim 4, wherein the core monitor includes a core monitoring queue,
further comprising:
monitoring, by the core monitor, a frontmost part of the core monitoring queue;
determining a priority of usage information of a core having the allocated task based on estimated time arrival (ETA) and adding the usage information to the core monitoring queue, wherein, as the ETA is short, the priority is high; and
when the task is completely allocated, causing a polling operation to be pending by using a sleep as much as ETA of a core at the frontmost part of the core monitoring queue,
wherein the core at the frontmost part of the monitoring queue is a core having the smallest ETA, and
wherein the at least one core is controlled through a single thread.

6. A hardware accelerator controlling device, the device comprising:
a hardware accelerator including at least one core and configured to program a time-critical task; and
a software framework connected to the hardware accelerator configured to program the time-critical task,
wherein the software framework is configured to:
instantiate a task force, which is a task management unit provided by the software framework, through an application;
configure metadata by using the instantiated task force; and
register the task force thus configured in the software framework by the application.

7. The device of claim 6, wherein the software framework is configured to program the hardware accelerator based on an accelerator core setting included in the metadata of a task force requested to be registered.

8. The device of claim 7, wherein the application is further configured to:
make a request for task processing to the software framework and the hardware accelerator through the instantiated task force registered in the software framework;
manage a received task by adding the received task to a task queue; and
when a new task is added to the task queue, provide a notification of a signal indicating that the new task is added to the core monitor by the task force.

9. The device of claim 8, wherein the core monitor is further configured to:
monitor the at least one core included in the hardware accelerator;
when there is a task to be processed during the monitoring, determine whether there is an available core among the at least one core; and
when the available core is found, remove a task from the task queue of the task force and allocate a task to the available core of the hardware accelerator.

10. The device of claim 9, wherein the core monitor includes a core monitoring queue, and
wherein the core monitor is further configured to:
monitor a frontmost part of the core monitoring queue;
determine a priority of usage information of a core having the allocated task based on ETA and add the usage information to the core monitoring queue, wherein, as the ETA is short, the priority is high; and
when the task is completely allocated, cause a polling operation to be pending by using a sleep as much as ETA of a core at the frontmost part of the core monitoring queue,
wherein the core at the frontmost part of the monitoring queue is a core having the smallest ETA, and
wherein the at least one core is controlled through a single thread.
